(19) United States
(12) Patent Application Publication
(10) Pub. No.: US 2022/0239325 A1
(43) Pub. Date: Jul. 28, 2022

(54) CASING DEVICE, REMOTE CONTROL SYSTEM, AND POWER SUPPLY CONTROL DEVICE

(71) Applicant: KABUSHIKI KAISHA TOKAI RIKA DENKI SEISAKUSHO, Aichi (JP)

(72) Inventors: Masanori KOSUGI, Aichi (JP); Hideki KAWAI, Aichi (JP)

(73) Assignee: KABUSHIKI KAISHA TOKAI RIKA DENKI SEISAKUSHO, Aichi (JP)

(21) Appl. No.: 17/583,683

(22) Filed: Jan. 25, 2022

(30) Foreign Application Priority Data
Jan. 27, 2021 (JP) 2021-011059

(51) Int. Cl. H04B 1/3888; H04M 1/02

(52) U.S. Cl. CPC H04B 1/3888; H04M 1/0249

(57) ABSTRACT

A casing has a housing section adapted to house a communication device. The communication device is configured to transmit, in response to a first signal, a second signal for controlling a controlled device. A controller is configured to cause an actuator to actuate a movable portion of the communication device so as to transmit the second signal in a case where the communication device receives a trigger signal from a mobile device adapted to be carried by a user. The controller is configured to cause a power supply control device to disable power supply a power source to the communication device in a case where an intensity of the first signal detected by a detector is no less than a threshold value while the first signal is not received by the communication device.

### FIELD

The presently disclosed subject matter relates to a casing device adapted to be disposed in a prescribed space in order to house a communication device that is configured to output information necessary for control of a controlled device. The presently disclosed subject matter also relates to a remote control system including the casing device. The presently disclosed subject matter also relates to a power supply control device configured to control power supply from a power supply to the communication device.

### BACKGROUND

European Patent Publication No. 3418985A1 discloses a casing device adapted to be disposed in a vehicle cabin opened and closed by a door of a vehicle. The casing device includes a housing section, a transceiver, and an actuator. The housing section houses an electronic key as an example of the communication device. The electronic key is a device configured to cause a control device installed in the vehicle to control a locking/unlocking device configured to lock/unlock the door through wireless communication when a specific operation is performed. The locking/unlocking device is an example of the controlled device. When the transceiver receives a locking/unlocking instruction from a mobile device adapted to be carried by a user, the actuator performs the specific operation described above with respect to the electronic key. As a result, in a state that the electronic key is left in the vehicle cabin, it is possible to remotely control the operation of the locking/unlocking device with the mobile device from, for example, the outside of the vehicle cabin.

### SUMMARY

It is demanded to suppress occurrence of a situation that a controlled device is unexpectedly controlled.

In order to meet the demand described above, a first illustrative aspect of the presently disclosed subject matter provides a casing device adapted to be disposed in a prescribed space that is opened/closed by an opening/closing body, comprising:

a casing having a housing section adapted to house a communication device configured to cause a control device to perform control of a controlled device based on first wireless communication including reception of a first signal using a first frequency band and transmission of a second signal using a second frequency band as a response to the first signal;

an actuator configured to actuate a movable portion of the communication device housed in the housing section;

a transceiver configured to receive, based on second wireless communication, a trigger signal from a mobile device adapted to be carried by a user; and

a controller configured to cause the actuator to actuate the movable portion so as to cause the communication device to transmit the second signal in a case where the communication device receives the trigger signal;

a detector configured to an intensity of the first signal; and

a power supply control device configured to switch between a state that power supply from a power source to the communication device is enabled and a state the power supply is disabled,

wherein the controller is configured to cause the power supply control device to disable the power supply in a case where the intensity of the first signal detected by the detector is no less than a threshold value while the trigger signal is not received by the communication device.

In order to meet the demand described above, a second illustrative aspect of the presently disclosed subject matter provides a remote control system, comprising:

a casing device adapted to be disposed in a prescribed space that is opened/closed by an opening/closing body;

a control device configured to perform control of a controlled device; and

a communication device configured to cause the control device to perform the control of the controlled device based on first wireless communication including reception of a first signal using a first frequency band and transmission of a second signal using a second frequency band as a response to the first signal,

wherein the casing device includes:
a casing having a housing section adapted to house the communication device;
an actuator configured to actuate a movable portion of the communication device housed in the housing section;
a transceiver configured to receive, based on second wireless communication, a trigger signal from a mobile device adapted to be carried by a user; and
a controller configured to cause the actuator to actuate the movable portion so as to cause the communication device to transmit the second signal in a case where the communication device receives the trigger signal;
a detector configured to an intensity of the first signal; and
a power supply control device configured to switch between a state that power supply from a power source to the communication device is enabled and a state the power supply is disabled,

wherein the controller is configured to cause the power supply control device to disable the power supply in a case where the intensity of the first signal detected by the detector is no less than a threshold value while the trigger signal is not received by the communication device.

With the configuration according to each of the first aspect and second aspects described above, even if the first signal unexpectedly arrives at the casing device in a situation that the user does not intend to perform the operation control of the controlled device with the mobile device, the second signal is not transmitted from the communication device, so that the control device can be prevented from performing the operation control of the controlled device. In other words, it is possible to reduce a possibility that the controlled device is unexpectedly controlled in the state that the communication device is housed in the casing device disposed in the prescribed space.

In order to meet the demand described above, a third illustrative aspect of the presently disclosed subject matter provides a power supply control device configured to control power supply from a power source to a communication device configured to output information necessary for controlling a controlled device, comprising:

a conductive path being switchable between a conductive state that the power source and the communication device are electrically connected, and an insulative state that the power source and the communication device are electrically isolated; and

a switching element configured to switch the conductive path from the conductive state to the insulative state based on a force generated without contact.

With the configuration according to the third aspect described above, it is possible to cut off the power supply from the power source to the communication device in a situation that the user does not intend to perform the operation control of the controlled device with the mobile device. Accordingly, it is possible to suppress the occurrence of a situation that the controlled device is unexpectedly controlled.

### BRIEF DESCRIPTION OF DRAWINGS

FIG. 1 illustrates a configuration of a remote control system according to an embodiment.

FIG. 2 illustrates an exemplary configuration of a casing device of FIG. 1.

FIG. 3 illustrates an exemplary operation of the casing device of FIG. 2.

FIG. 4 illustrates a battery control device attached to a battery of an electronic key of FIG. 2.

FIG. 5 illustrates an exemplary configuration of the battery control device of FIG. 4.

FIG. 6 illustrates of an exemplary operation of the casing device of FIG. 2.

FIG. 7 illustrates of an exemplary operation of the casing device of FIG. 2.

FIG. 8 illustrates a specific configuration of a controller of FIG. 2.

FIG. 9 illustrates an exemplary flow of processing to be executed by the controller of FIG. 8.

FIG. 10 illustrates another exemplary flow of processing to be executed by the controller of FIG. 8.

FIG. 11 illustrates of another exemplary operation of the casing device of FIG. 2.

FIG. 12 illustrates of another exemplary operation of the casing device of FIG. 2.

FIG. 13 illustrates another exemplary configuration of the battery control device of FIG. 4.

FIG. 14 illustrates another exemplary configuration of the casing device of FIG. 1.

FIG. 15 illustrates of an exemplary operation of the casing device of FIG. 14.

FIG. 16 illustrates another exemplary configuration of the casing device of FIG. 1.

FIG. 17 illustrates of an exemplary operation of the casing device of FIG. 16.

FIG. 18 illustrates another exemplary configuration of the casing device of FIG. 1.

FIG. 19 illustrates of an exemplary operation of the casing device of FIG. 18.

FIG. 20 illustrates another exemplary flow of processing to be executed by the controller of FIG. 8.

FIG. 21 illustrates a battery control device adapted to be used independently of the casing device.

### DESCRIPTION OF EMBODIMENTS

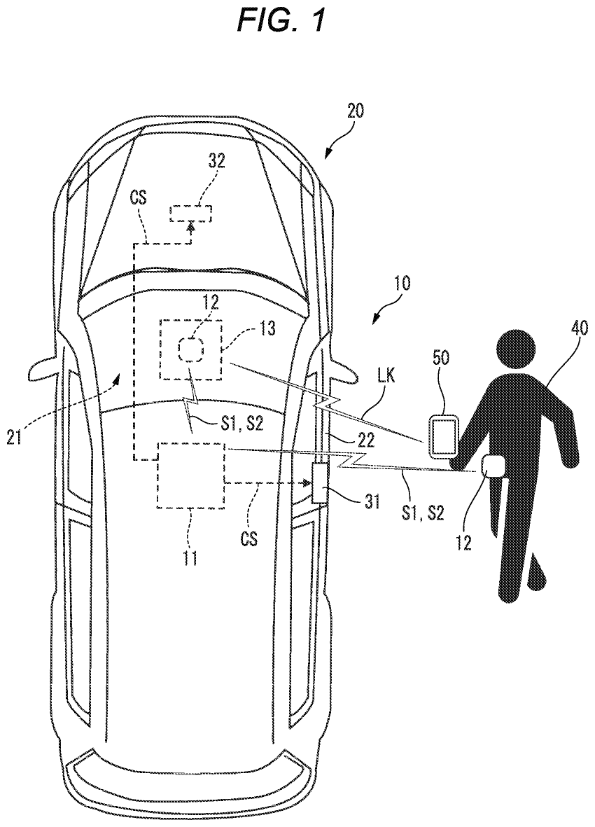

Exemplary embodiments will be described in detail below with reference to the accompanying drawings. FIG. 1 illustrates a configuration of a remote control system 10 according to an embodiment. In each of the drawings, the scale is appropriately changed in order to make each element illustrated have a recognizable size.

The remote control system 10 includes a control device 11. The control device 11 is installed in a vehicle 20. The control device 11 is configured to control the operation of a locking/unlocking device 31 installed in the vehicle 20. The locking/unlocking device 31 is a device configured to lock/unlock a door 22 for opening/closing a vehicle cabin 21 of the vehicle 20. The vehicle 20 is an example of a mobile entity. The vehicle cabin 21 is an example of the prescribed space. The door 22 is an example of an opening/closing body. The locking/unlocking device 31 is an example of the controlled device.

The remote control system 10 includes an electronic key 12. The electronic key 12 is a device adapted to be carried by a user 40. The electronic key 12 is a device capable of causing the control device 11 to control the operation of the locking/unlocking device 31 based on first wireless communication. The first wireless communication includes transmitting and receiving a first signal S1 using a first frequency band and a second signal S2 using a second frequency band. The first frequency band and the second frequency band are different from each other. Examples of the first frequency band include a low frequency (LF) band. Examples of the second frequency band include an ultra high frequency (UHF) band. In other words, the electronic key 12 outputs information necessary for controlling the locking/unlocking device 31.

Specifically, the control device 11 transmits the first signal S1 through a communication device disposed at an appropriate position in the vehicle 20. The transmission of the first signal S1 may be performed continuously or intermittently. The electronic key 12 includes a communication device including an antenna capable of receiving the first signal S1 and transmitting the second signal S2. The electronic key 12 is configured to transmit the second signal S2 upon receiving the first signal S1. The second signal S2 is configured to include authentication information required for the authentication of the electronic key 12. The authentication information is information capable of specifying at least one of the electronic key 12 and the user 40.

The control device 11 is configured to execute authentication processing upon reception of the second signal S2 through a communication device disposed at an appropriate position in the vehicle 20. Specifically, the control device 11 is configured to match the authentication information included in the second signal S2 with authentication information of the electronic key 12 stored in a storage device (not illustrated) in advance. When the matching degree between the two pieces of information exceeds a threshold value, the control device 11 determines that the authentication of the electronic key 12 is succeeded.

When it is determined that the authentication of the electronic key 12 is succeeded, the control device 11 is configured to output a control signal CS for causing the locking/unlocking device 31 to perform the locking/unlocking operation. For example, the locking/unlocking device 31 may be configured to perform the locking/unlocking of the door 22 when the user 40 touches a touch sensor provided on the door handle in a state that the authentication of the electronic key 12 is succeeded.

That is, when the user 40 carrying the electronic key 12 enters an area capable of receiving the first signal S1, the authentication of the electronic key 12 is performed through the first wireless communication. When the authentication is succeeded, the user 40 can lock/unlock the door 22 without performing an operation such as inserting and rotating a key into a key cylinder.

The remote control system 10 includes a casing device 13. The casing device 13 is configured to be disposed in the vehicle cabin 21 of the vehicle 20. The casing device 13 is configured to house the electronic key 12. That is, the electronic key 12 can be disposed in the vehicle cabin 21.

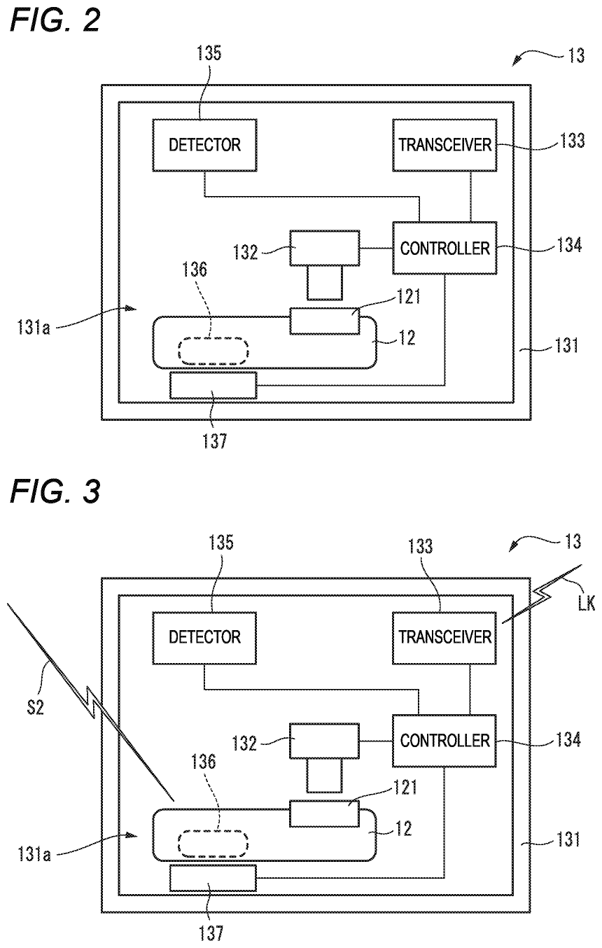

FIG. 2 illustrates an exemplary configuration of the casing device 13. The casing device 13 includes a casing 131. The casing 131 includes a housing section 131a in which the electronic key 12 is housed. The housing 131 is formed of a material capable of allowing the first signal S1 and the second signal S2 to permeate.

The casing device 13 includes an actuator 132. The actuator 132 is configured to actuate a movable portion 121 of the electronic key 12 housed in the housing section 131a. The electronic key 12 is configured to transmit the second signal S2 regardless of the reception state of the first signal S1 when a prescribed operation is performed with respect to the movable portion 121. The movable portion 121 can be implemented by a button, a lever, or the like. The actuator 132 may be implemented by a solenoid, a cam mechanism, a rack-and-pinion mechanism, or the like. Examples of the actuation of the movable portion 121 for causing the electronic key 12 to transmit the second signal S2 include N-times repetitive depressions and the like.

The casing device 13 includes a transceiver 133. The transceiver 133 includes an antenna for performing second wireless communication with a mobile device 50. As illustrated in FIG. 1, the mobile device 50 is a device adapted to be carried by the user 40. Examples of the mobile device 50 include a general-purpose portable information terminal such as a smartphone. In this example, the second wireless communication is short-range wireless communication.

As used herein, the term “short-range wireless communication” means wireless communication performed in accordance with standard IEEE 802.15 or IEEE 802.11. Examples of the technology capable of executing such wireless communication include Bluetooth (registered trademark), Bluetooth Low Energy (registered trademark), UWB (Ultra Wide Band), ZigBee (registered trademark), and Wi-Fi (registered trademark). As used herein, the term “short-range wireless communication” is distinguished from “near field wireless communication” performed with a non-contact communication technique in which a mobile device transmits information upon reception of minute power from a radio wave transmitted from a reading device. Examples of the technique capable of executing the near field wireless communication include an RF-ID and an NFC.

When it is desired to lock/unlock the door 22 of the vehicle 20 in a state that the electronic key 12 is housed in the casing device 13, the user 40 performs a prescribed operation with respect to the mobile device 50. As illustrated in FIG. 1, the mobile device 50 is configured to transmit a lock/unlock signal LK based on the prescribed operation. The lock/unlock signal LK is an example of a trigger signal.

As illustrated in FIG. 2, the casing device 13 includes a controller 134. The controller 134 is configured to control the operation of the actuator 132. Specifically, as illustrated in FIG. 3, the controller 134 is configured to cause the actuator 132 to perform an actuation of the movable portion 121 for causing the electronic key 12 to transmit the second signal S2 when the transceiver 133 receives the lock/unlock signal LK. In brief, when the transceiver 133 receives the lock/unlock signal LK, the second signal S2 is transmitted from the electronic key 12.

The second signal S2 transmitted from the electronic key 12 is received by the control device 11 installed in the vehicle 20. As described above, when the second signal S2 is received, the control device 11 performs the authentication processing of the electronic key 12, and outputs the control signal CS for causing the locking/unlocking device 31 to lock/unlock the door 22.

Accordingly, when the user 40 transmits the lock/unlock signal LK from the mobile device 50 in the state that the electronic key 12 is housed in the casing device 13 disposed in the vehicle cabin 21, the door 22 can be locked/unlocked. In other words, the user 40 can lock/unlock the door 22 by the prescribed operation with respect to the mobile device 50 from outside the vehicle cabin 21 without carrying the electronic key 12.

As illustrated in FIG. 2, the casing device 13 includes a detector 135. The detector 135 includes an antenna capable of detecting an intensity of a signal using the first frequency band. In other words, the detector 135 can detect the intensity of the first signal S1.

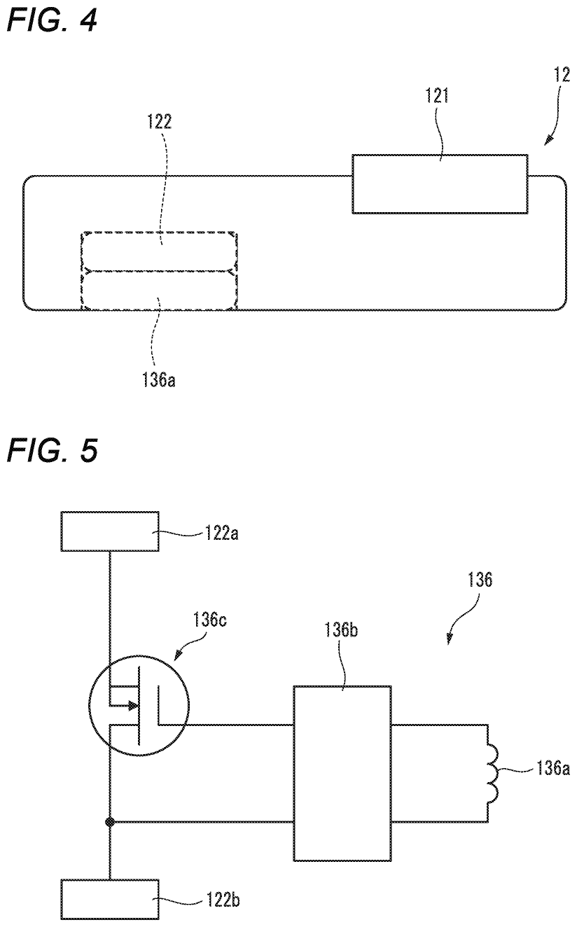

The casing device 13 includes a battery control device 136. As illustrated in FIG. 4, the battery control device 136 is configured to be attached to a battery 122 for supplying power required for the operation of the electronic key 12. The battery 122 is an example of a power source.

FIG. 5 illustrates an exemplary configuration of the battery control device 136. The battery control device 136 includes a coil 136a, a rectifying circuit 136b, and a switching element 136c. The switching element 136c is configured to electrically isolate a positive electrode 122a and a negative electrode 122b of the battery 122 when power is supplied from the coil 136a. In this example, a depletion-type N-channel field-effect transistor (FET) is used as the switching element 136c. That is, the battery control device 136 is configured to switch between a state that the power supply from the battery 122 to the electronic key 12 is enabled and a state that the power supply from the battery 122 to the electronic key 12 is disabled. The battery control device 136 is an example of a power supply control device.

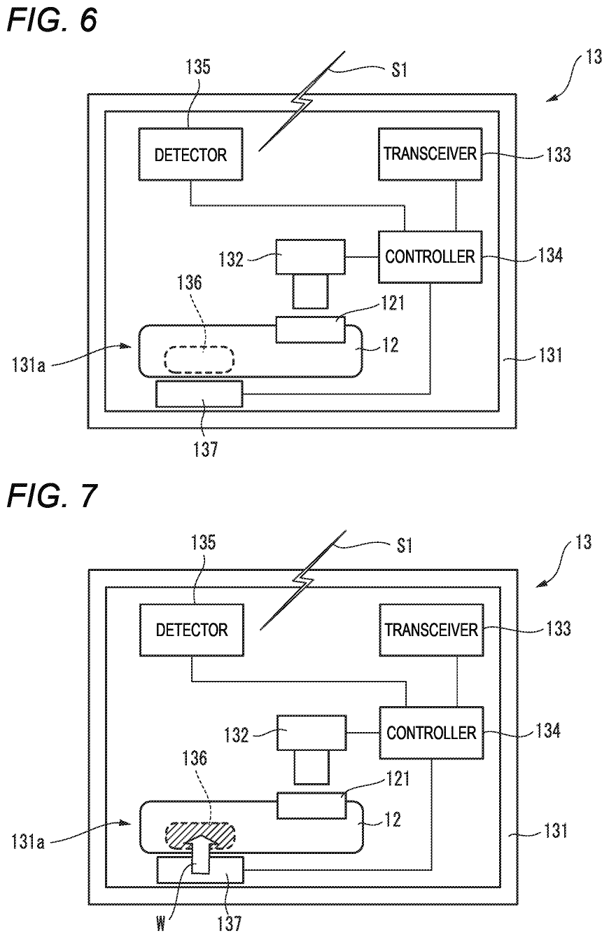

As illustrated in FIG. 6, the casing device 13 includes a radio source 137. In this example, the radio source 137 includes an antenna for transmitting a radio wave. The controller 134 is configured to switch between a state that a high frequency signal is supplied to the antenna and a state that the high frequency is not supplied. When a high frequency signal is supplied to the antenna, as illustrated in FIG. 7, a radio wave W is generated from the radio source 137.

When the radio wave W generated from the radio source 137 reaches the coil 136a of the battery control device 136, an induced electromotive force is generated in the coil 136a, so that the switching element 136c receives power from the coil 136a with the electromagnetic induction. Accordingly, the positive electrode 122a and the negative electrode 122b of the battery 122 are electrically isolated, so that the power supply to the electronic key 12 is stopped. The induced electromotive force is an example of a force generated without contact.

In the accompanying drawings, the battery control device 136 without hatching represents a state that the power supply from the battery 122 to the electronic key 12 is enabled. The battery control device 136 with hatching indicates a state that the power supply from the battery 122 to the electronic key 12 is disabled.

The controller 134 is configured to supply a high frequency signal to the antenna of the radio source 137 to generate the radio wave W in a case where the intensity of the first signal S1 detected by the detector 135 is no less than a threshold value while the transceiver 133 does not receive the lock/unlock signal LK. The threshold value may be set so as to be less than the reception intensity of the first signal S1 at the electronic key 12 necessary for transmitting the second signal S2. As a result, the battery control device 136 disables the power supply from the battery 122 to the electronic key 12. Accordingly, the second signal S2 is not transmitted from the electronic key 12.

According to the configuration of the present embodiment, even if the first signal S1 unexpectedly arrives at the casing device 13 in a situation that the user 40 does not intend to perform the locking/unlocking of the door 22 with the mobile device 50, the second signal S2 is not transmitted from the electronic key 12, so that the control device 11 can be prevented from performing the operation control of the locking/unlocking device 31. In other words, it is possible to reduce a possibility that the door 22 is unexpectedly locked/unlocked in the state that the electronic key 12 is housed in the casing device 13 disposed in the vehicle cabin 21. Accordingly, it is possible to improve the security of the casing device 13 adapted to be disposed in the vehicle cabin 21 in order to house the electronic key 12 to be remotely controlled. It is also possible to improve the security of the remote control system 10 including the casing device 13.

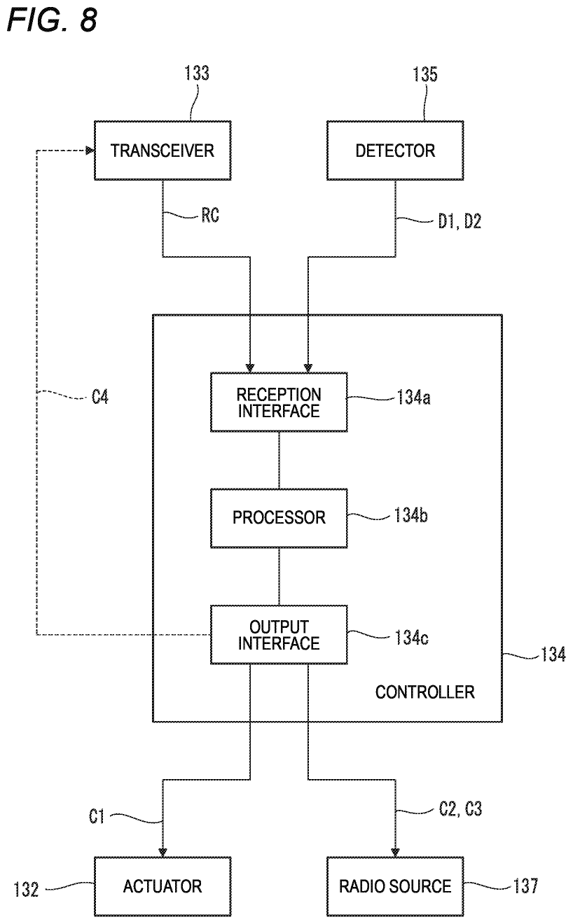

FIG. 8 illustrates a more specific configuration of the controller 134 of the casing device 13 configured as described above. The controller 134 includes a reception interface 134a, a processor 134b, and an output interface 134c.

The reception interface 134a is configured as an interface capable of receiving a reception signal RC indicating that the lock/unlock signal LK transmitted from the mobile device 50 is received by the transceiver 133. Instead of the reception signal RC, the lock/unlock signal LK itself may be inputted to the reception interface 134a.

The detector 135 is configured to output a first detection signal D1 corresponding to the intensity of the first signal S1 as detected. The reception interface 134a is configured as an interface capable of receiving the first detection signal D1 as well.

The processor 134b is configured to output, from the output interface 134c, a first control signal C1 for causing the actuator 132 to perform an actuation of the movable portion 121 for causing the electronic key 12 to transmit the second signal S2 when the reception interface 134a receives the reception signal RC.

In addition, the processor 134b is configured to output, from the output interface 134c, a second control signal C2 for causing the radio source 137 to generate the radio wave W, in a case where the intensity of the first signal S1 corresponding to the first detection signal D1 is no less than a threshold value while the reception interface 134a does not receive the reception signal RC. It should be noted that the processor 134b is configured to output, from the output interface 134c, a third control signal C3 for causing the radio source 137 to stop generating the radio wave W.

In brief, the output interface 134c is configured as an interface for outputting a signal for causing the actuator 132 and the radio source 137 to perform desired operations.

The processor 134b having the above-described function can be implemented by a processing element such as a microcontroller.

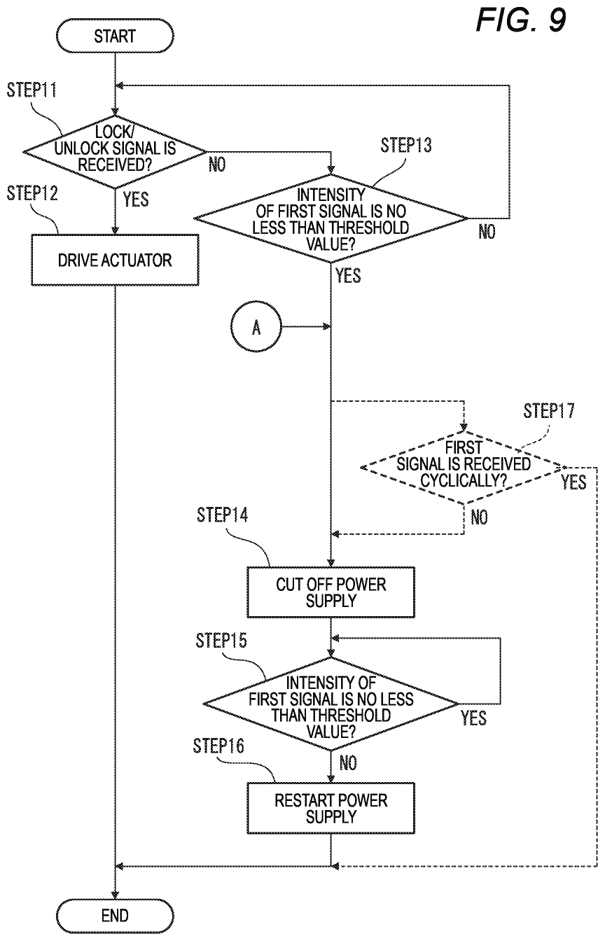

FIG. 9 illustrates a flow of processing to be executed by the processor 134b of the controller 134 configured as described above.

The processor 134b determines whether the transceiver 133 receives the lock/unlock signal LK from the mobile device 50 (STEP11).

When it is determined that the lock/unlock signal LK is received (YES in STEP11), the processor 134b outputs, from the output interface 134c, the first control signal C1 for causing the actuator 132 to actuate the movable portion 121 of the electronic key 12 (STEP12). As a result, the second signal S2 is transmitted from the electronic key 12. The second signal S2 is transmitted to the outside of the casing device 13, and is received by the control device 11. The control device 11 having received the second signal S2 causes the locking/unlocking device 31 to perform the locking/unlocking operation of the door 22.

When it is determined that the lock/unlock signal LK is not received (NO in STEP11), the processor 134b determines whether the intensity of the first signal S1 detected by the detector 135 is no less than the threshold value (STEP13). When the intensity of the first signal S1 detected by the detector 135 is less than the threshold value (NO in STEP13), the processing returns to STEP11.

When it is determined that the intensity of the first signal S1 detected by the detector 135 is no less than the threshold value (YES in STEP13), the processor 134b outputs, from the output interface 134c, the second control signal C2 for causing the radio source 137 to generate the radio wave W (STEP14). As a result, the battery control device 136 disables the power supply from the battery 122 to the electronic key 12.

Subsequently, the processor 134b determines whether the intensity of the first signal S1 detected by the detector 135 is no less than the threshold value (STEP15). The processing is repeated until it is determined that the intensity of the first signal S1 detected by the detector 135 is less than the threshold value (YES in STEP15).

When it is determined that the intensity of the first signal S1 detected by the detector 135 is less than the threshold value (NO in STEP15), the processor 134b outputs, from the output interface 134c, the third control signal C3 for causing the radio source 137 to stop generating the radio wave W (STEP16). In other words, the generation of the radio wave W is continued until the intensity of the first signal S1 that has unexpectedly arrived decreases to a value less than the threshold value.

The processor 134b may be configured to acquire an elapsed time length since the previous determination was made in a case where it is determined that the intensity of the first signal S1 detected by the detector 135 is no less than the threshold value (YES in STEP13). In this case, the processor 134b may be configured to determine whether the intensity of the first signal S1 detected by the detector 135 cyclically exceeds the threshold value based on the elapsed time lengths acquired more than once (STEP17).

When it is determined that the intensity of the first signal S1 detected by the detector 135 does not cyclically exceeds the threshold value (NO in STEP17), the processor 134b outputs, from the output interface 134c, the second control signal C2 for causing the radio source 137 to generate the radio wave W (STEP14).

When it is determined that the intensity of the first signal S1 detected by the detector 135 cyclically exceeds the threshold value (YES in STEP17), the processor 134b stops the generation of the radio wave W by the radio source 137, and terminates the processing.

For example, another vehicle employing a similar remote control system may be parked next to the vehicle 20, so that a first signal S1 may be cyclically transmitted from a control device installed in another vehicle. According to the configuration as described above, it is possible to suppress power consumption caused by repetition of the generation of the radio wave W in response to the arrival of such a first signal S1.

The detector 135 may include an antenna capable of detecting an intensity of a signal using the second frequency band. In other words, the detector 135 may be so configured as to be able to detect the intensity of the second signal S2 as well. In this case, as illustrated in FIG. 8, the detector 135 is configured to output a second detection signal D2 corresponding to the intensity of the detected second signal S2. The reception interface 134a is configured as an interface capable of receiving the second detection signal D2 as well.

In this case, the processor 134b may be configured to output, from the output interface 134c, the second control signal C2 for causing the radio source 137 to generate the radio wave W in a case where the intensity of the second signal S2 corresponding to the second detection signal D2 is no less than a threshold value while the reception interface 134a does not receive the reception signal RC. The threshold value is determined so as to correspond to the intensity of the second signal S2 transmitted from the electronic key 12.

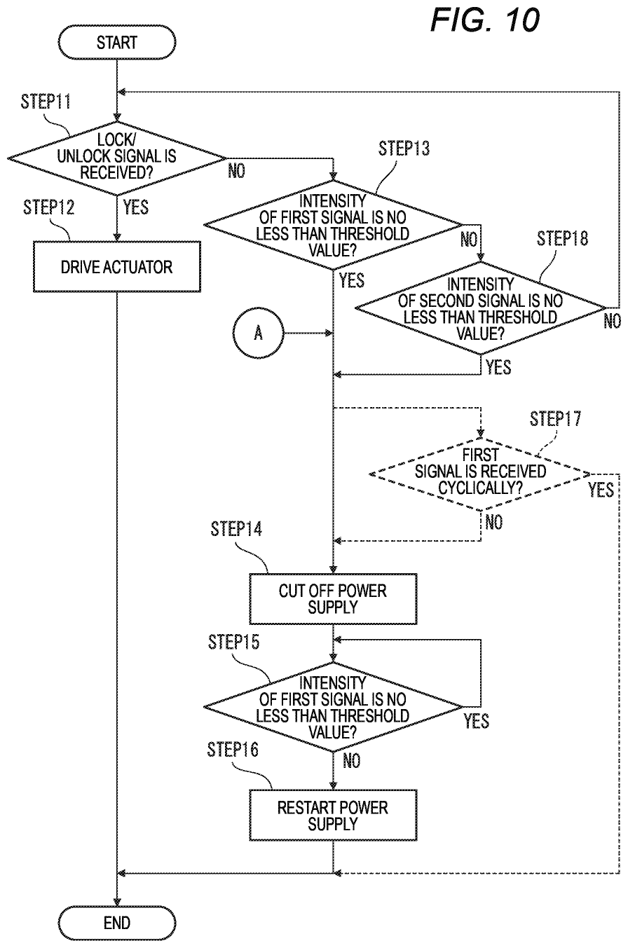

For example, as illustrated in FIG. 10, in a case where the intensity of the first signal S1 detected by the detector 135 is less than the threshold value while the reception interface 134a does not receive the reception signal RC (NO in STEP13), the processor 134b determines whether the intensity of the second signal S2 detected by the detector 135 is no less than the threshold value (STEP18).

When it is determined that the intensity of the second signal S2 detected by the detector 135 is less than the threshold value (NO in STEP18), the processing returns to STEP11.

When it is determined that the intensity of the second signal S2 detected by the detector 135 is no less than the threshold value (YES in STEP18), the processor 134b outputs, from the output interface 134c, the second control signal C2 for causing the radio source 137 to generate the radio wave W (STEP14).

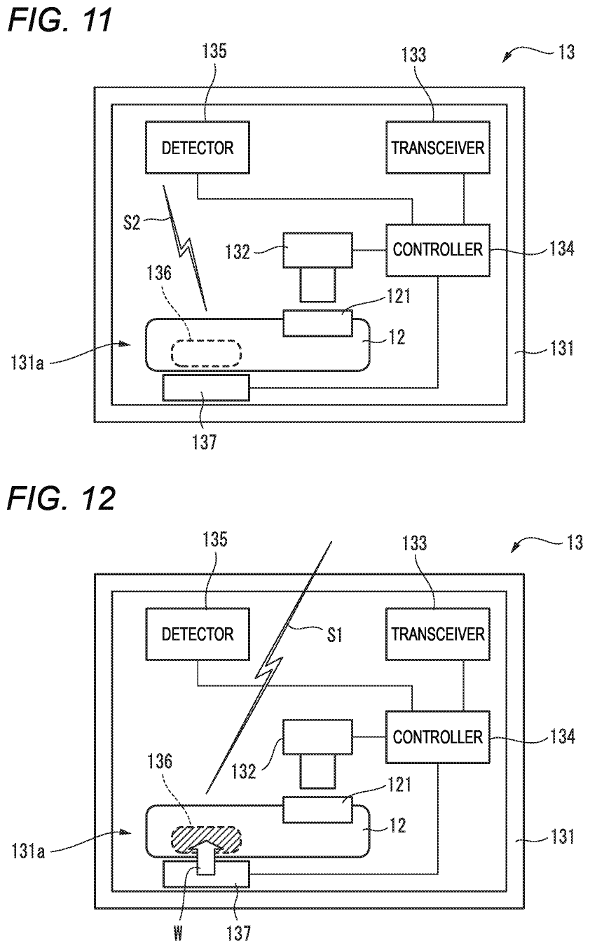

As illustrated in FIG. 11, the second signal S2 may be unexpectedly transmitted from the electronic key 12 due to arrival of such a first signal S1 that has an intensity less than the threshold value. In such a specification that the first signal S1 and the second signal S2 are communicated with the control device 11 more than once until the operation control of the locking/unlocking device 31 is enabled, the power supply from the battery 122 is cut off by the second signal S2 is transmitted from the electronic key 12 for the first time. Accordingly, as illustrated in FIG. 12, it is possible to prevent the second signal S2 from being transmitted in response to a first signal S2 that arrives subsequently. As a result, it is possible to reduce a possibility that the door 22 is locked/unlocked by the second signal S2 unexpectedly transmitted from the electronic key 12.

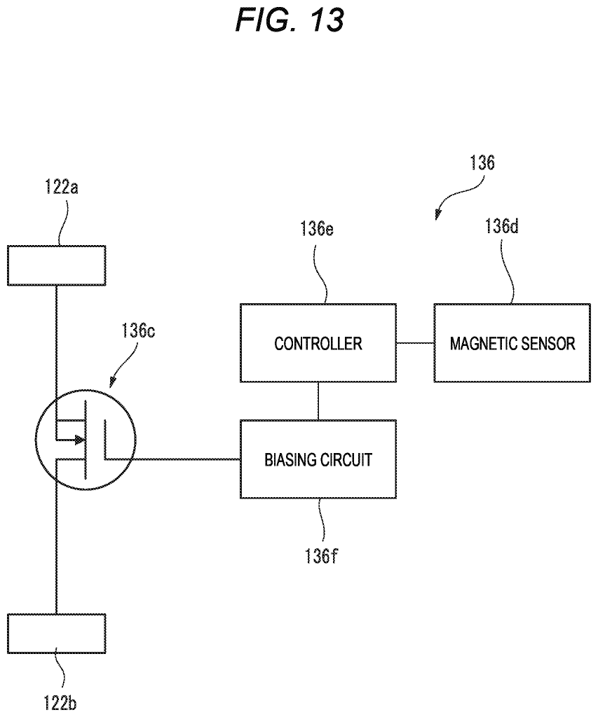

FIG. 13 illustrates another exemplary configuration of the battery control device 136. In this example, the battery control device 136 includes a magnetic sensor 136d in place of the coil 136a and the rectifying circuit 136b. The magnetic sensor 136d is configured to detect a magnetic force, and to output a signal corresponding to a strength of the detected magnetic force. The magnetic sensor 136d can be implemented by, for example, a magnetoresistive element, a Hall element, or the like.

The battery control device 136 according to the present example includes a controller 136e and a biasing circuit 136f. The signal outputted from the magnetic sensor 136d is inputted to the controller 136e. The controller 136e is configured to control the biasing circuit 136f so that power is supplied to the switching element 136c when a signal corresponding to a magnetic force having a strength exceeding a threshold value is inputted from the magnetic sensor 136d. The controller 136e may be implemented by a control element such as a microcontroller.

Namely, in the battery control device 136 according to the present example, when a magnetic force having a strength exceeding the threshold value is applied to the magnetic sensor 136d, power is supplied to the switching element 136c, so that the positive electrode 122a and the negative electrode 122b of the battery 122 are electrically isolated. In other words, the switching element 136c is configured to electrically isolate the positive electrode 122a and the negative electrode 122b of the battery 122 when the strength of the magnetic force detected by the magnetic sensor 136d exceeds the threshold value. The magnetic force is an example of the force generated without contact.

The magnetic sensor 136d and the controller 136e can be operated by receiving power supplied from the battery 122. However, power may be supplied from a power source (not illustrated) independent of the battery 122. In this case, the controller 136e may be configured to intermittently supply power from the power source to the magnetic sensor 136d.

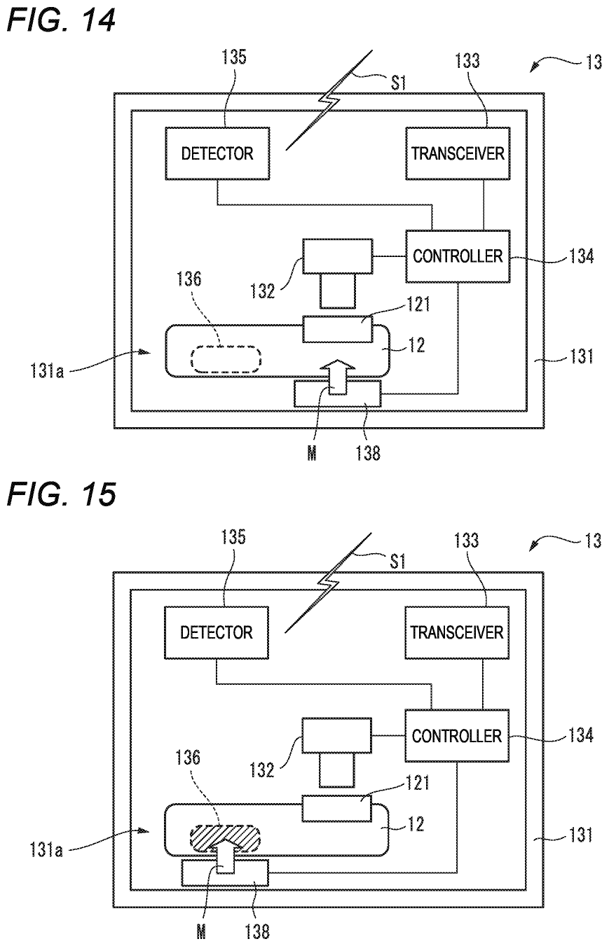

FIG. 14 illustrates another exemplary configuration of the casing device 13. The casing device 13 according to the present example includes a permanent magnet 138. The strength of the magnetism M generated from the permanent magnet 138 is determined to such an extent that power can be supplied to the switching element 136c through the magnetic sensor 136d illustrated in FIG. 13.

The controller 134 according to the present example is configured to be capable of changing the position of the permanent magnet 138 by actuating an actuator (not illustrated). The actuator can be implemented by a solenoid, a cam mechanism, a rack-and-pinion mechanism, or the like.

In the initial state illustrated in FIG. 14, the permanent magnet 138 is disposed at a position remote from the battery control device 136. Specifically, the permanent magnet 138 is disposed at a position where power cannot be supplied to the switching element 136c through the magnetic sensor 136d by the magnetism M generated from the permanent magnet 138.

As illustrated in FIG. 15, when the intensity of the first signal S1 or the second signal S2 detected by the detector 135 is no less than the threshold value while the transceiver 133 does not receive the lock/unlock signal LK, the controller 134 causes the permanent magnet 138 to approach the battery control device 136. When the magnetism M from the permanent magnet 138 is detected by the magnetic sensor 136d and the power supply to the switching element 136c is initiated, the battery control device 136 disables the power supply from the battery 122 to the electronic key 12. Namely, the controller 134 causes the battery control device 136 to disable the supply power from the battery 122 to the electronic key 12 by increasing the magnetic force to be detected by the magnetic sensor 136d.

In this example, the second control signal C2 illustrated in FIG. 8 is used to displace the permanent magnet 138 from the position illustrated in FIG. 14 to the position illustrated in FIG. 15. The third control signal C3 is used to displace the permanent magnet 138 from the position illustrated in FIG. 15 to the position illustrated in FIG. 14.

In the case of the configuration using the radio source 137 described with reference to FIGS. 2 to 11, it is necessary to supply power to the radio source 137 while causing the battery control device 136 to disable the supply power from the battery 122 to the electronic key 12. On the other hand, in the case of the configuration according to the present example, power required for causing the battery control device 136 to disable the power supply from the battery 122 to the electronic key 12 only needs to be supplied when the actuator is activated to cause the permanent magnet 138 approach the battery control device 136. Accordingly, power consumption in the casing device 13 can be suppressed. From the viewpoint of suppressing the increase in the number of movable components, the configuration using the radio source 137 is also advantageous.

It should be noted that, instead of the switching element 136c illustrated in FIG. 13, a switching element for electrically isolating the positive electrode 122a and the negative electrode 122b of the battery 122 when the detected magnetic strength is less than the threshold value may be connected between the positive electrode 122a and the negative electrode 122b of the battery 122. Examples of such a switching element include a magnetic reed switch. In this case, the switching element serves as the magnetic sensor.

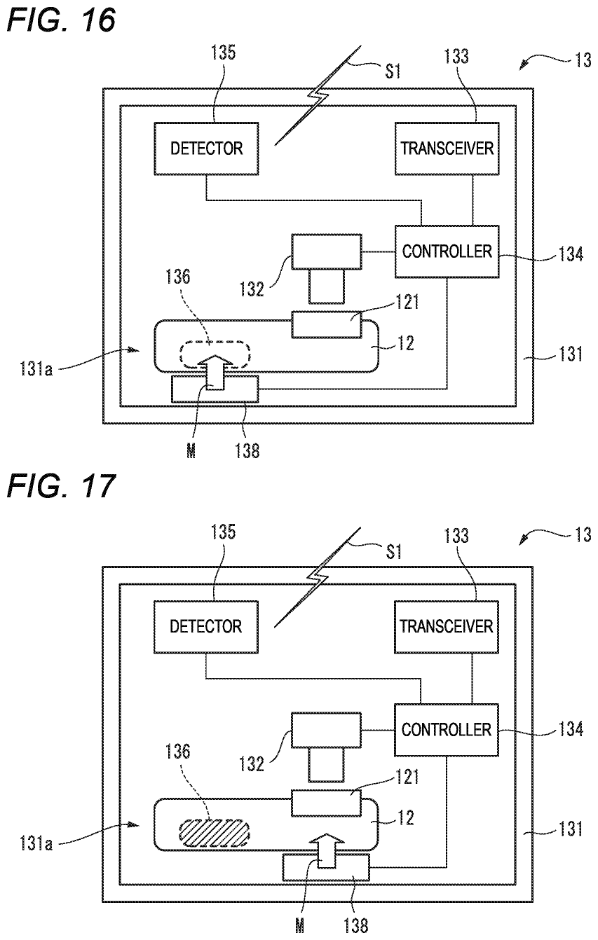

FIG. 16 illustrates a configuration of the casing device 13 that can be employed in this case. In the initial state illustrated in this figure, the permanent magnet 138 is disposed adjacent to the battery control device 136. Specifically, the permanent magnet 138 is disposed at a position where power can be supplied to the switching element 136c through the magnetic sensor 136d by the magnetism M generated from the permanent magnet 138.

As illustrated in FIG. 17, when the intensity of the first signal S1 or the second signal S2 detected by the detector 135 is no less than the threshold value while the transceiver 133 does not receive the lock/unlock signal LK, the controller 134 causes the permanent magnet 138 to depart from the battery control device 136. As the magnetism M from the permanent magnet is weakened, the switching element electrically isolates the positive electrode 122a and the negative electrode 122b of the battery 122. Accordingly, the battery control device 136 disables the power supply from the battery 122 to the electronic key 12. That is, the controller 134 causes the battery control device 136 to disable the supply power from the battery 122 to the electronic key 12 by weakening the magnetism M to be detected by the magnetic sensor.

In this example, the second control signal C2 illustrated in FIG. 8 is used to displace the permanent magnet 138 from the position illustrated in FIG. 16 to the position illustrated in FIG. 17. The third control signal C3 is used to displace the permanent magnet 138 from the position illustrated in FIG. 17 to the position illustrated in FIG. 16.

The magnetic sensor 136d illustrated in FIG. 13 may be configured to detect a change in the magnetic polarity. In this case, the controller 136e and the biasing circuit 136f may be configured to supply power to the switching element 136c when the magnetic polarity as detected changes, for example, from the N-pole to the S-pole. In other words, the switching element 136c may be configured to electrically isolate the positive electrode 122a and the negative electrode 122b of the battery 122 when the magnetic polarity as detected changes.

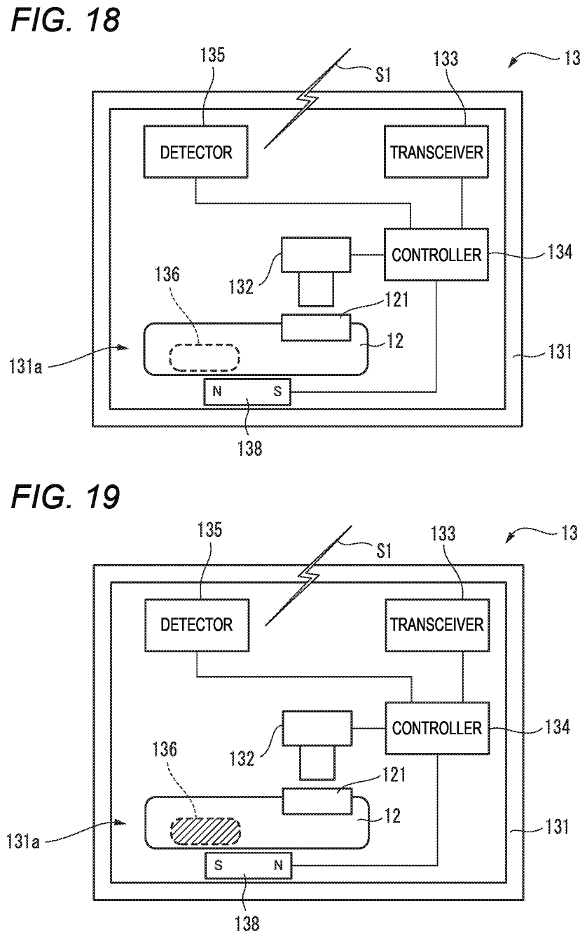

FIG. 18 illustrates a configuration of the casing device 13 that can be employed in this case. In the initial state illustrated in this figure, the N-pole is disposed adjacent to the battery control device 136.

The controller 134 according to the present example is configured to be capable of changing the magnetic pole of the permanent magnet 138 to be disposed adjacent to the battery control device 136 by actuating an actuator (not illustrated). The actuator can be implemented by a solenoid, a cam mechanism, a rack-and-pinion mechanism, or the like.

Specifically, as illustrated in FIG. 19, when the intensity of the first signal S1 or the second signal S2 detected by the detector 135 is no less than the threshold value while the transceiver 133 does not receive the lock/unlock signal LK, the controller 134 displaces the permanent magnet 138 such that the S-pole thereof is disposed adjacent to the battery control device 136. Since the magnetic pole detected by the magnetic sensor 136d changes from the N-pole to the S-pole, power is supplied to the switching element 136c, so that the power supply from the battery 122 to the electronic key 12 is disabled. Namely, the controller 134 causes the battery control device 136 to disable the supply power from the battery 122 to the electronic key 12 by changing the magnetic pole of the magnetism (the direction of the magnetic force) to be detected by the magnetic sensor 136d.

In this example, the second control signal C2 illustrated in FIG. 8 is used to change the permanent magnet 138 from the state illustrated in FIG. 18 to the state illustrated in FIG. 19. The third control signal C3 is used to change the permanent magnet 138 from the state illustrated in FIG. 19 to the state illustrated in FIG. 18.

The second signal S2 transmitted from the electronic key 12 can also be used for causing the control device 11 to perform the operation control of another controlled device installed in the vehicle 20. As illustrated in FIG. 1, another example of the controlled device includes an activator 32. The activator 32 is a device for activating a driving source of the vehicle 20. The driving source may be a combustion engine or an electric motor.

Specifically, the first signal S1 may be transmitted from a communication device disposed at an appropriate position in the vehicle 20 when the user 40 seated in a driver's seat steps on a brake pedal. When the electronic key 12 receives the first signal S1, the electronic key 12 transmits the second signal S2 as a response. When the second signal S2 is received by the control device 11, the authentication processing of the electronic key 12 is performed as described above. The control device 11 may be configured to output a control signal CS for causing the activator 32 installed in the vehicle 20 to activate the driving source when the user 40 touches, for example, an ignition switch in a state that the authentication of the electronic key 12 is succeeded.

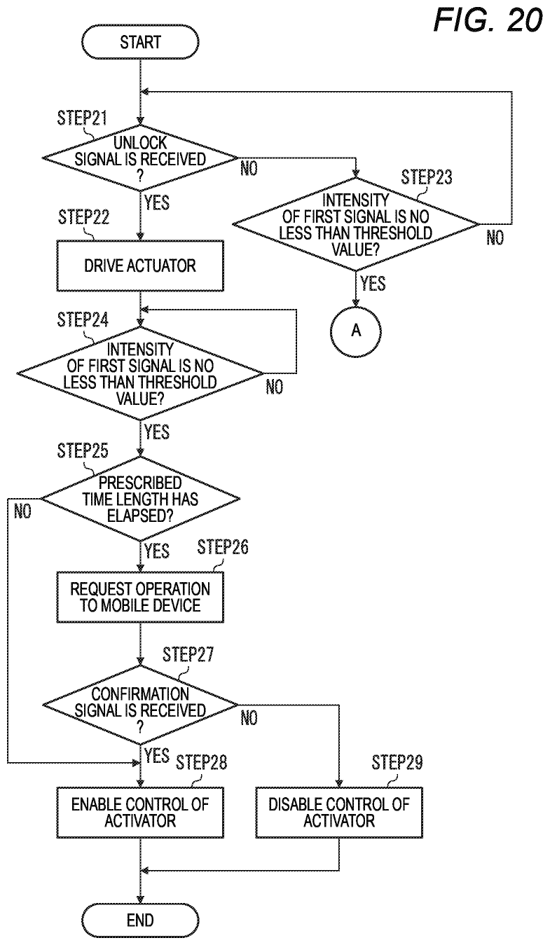

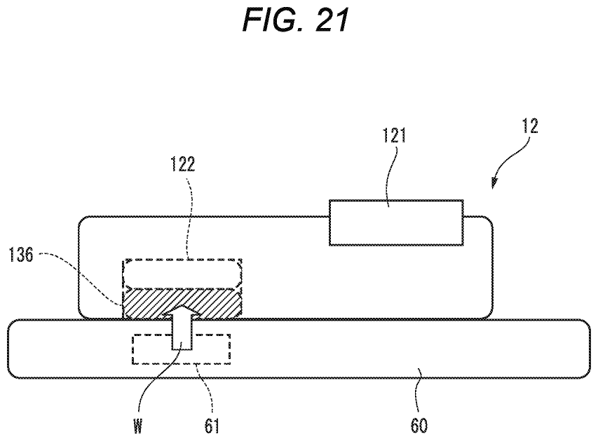

FIG. 20 illustrates a flow of processing that can be executed by the processor 134b of the casing device 13 in such a configuration.

The processor 134b determines whether the transceiver 133 receives an unlock signal for causing the locking/unlocking device 31 to unlock the door 22 from the mobile device 50 (STEP21).

When it is determined that the unlock signal is received (YES in STEP21), the processor 134b outputs, from the output interface 134c, the first control signal C1 for causing the actuator 132 to actuate the movable portion 121 of the electronic key 12 (STEP22). As a result, the second signal S2 is transmitted from the electronic key 12. The second signal S2 is transmitted to the outside of the casing device 13, and is received by the control device 11. The control device 11 having received the second signal S2 causes the locking/unlocking device 31 to perform the unlocking operation of the door 22.

When it is determined that the unlock signal is not received (NO in STEP21), the processor 134b determines whether the intensity of the first signal S1 detected by the detector 135 is no less than the threshold value (STEP23). When the intensity of the first signal S1 detected by the detector 135 is less than the threshold value (NO in STEP23), the processing returns to STEP21.

When the intensity of the first signal S1 detected by the detector 135 is less than the threshold value (YES in STEP23), the processing proceeds to STEP14 in FIG. 9. In other words, the processor 134b outputs, from the output interface 134c, the second control signal C2 for bring about a change in the radio source 137 according to each of the above examples. As a result, a first signal S1 coming unexpectedly is prevented from reaching the electronic key 12.

Subsequently, the processor 134b determines whether the intensity of the first signal S1 detected by the detector 135 is no less than the threshold value (STEP24). The processing is repeated until it is determined that the intensity of the first signal S1 detected by the detector 135 is no less than the threshold value (NO in STEP24). As described above, when the first signal S1 is transmitted from the control device 11 by the user 40 stepping on the brake pedal, the first signal S1 having an intensity no less than the threshold value is detected by the detector 135.

The processor 134b may be configured to acquire an elapsed time length since the processing of STEP21 is performed. When it is determined that the intensity of the first signal S1 detected by the detector 135 is no less than the threshold value (YES in STEP24), the processor 134b determines whether a prescribed time length has elapsed (STEP25). Examples of the prescribed time length include 30 seconds, 60 seconds, and the like.

When it is determined that the prescribed time length has elapsed at a time point when the first signal S1 having an intensity no less than the threshold value is detected (YES in STEP25), the processor 134b causes the transceiver 133 to transmit a confirmation request signal to the mobile device 50 (STEP26). Specifically, as illustrated in FIG. 8, a fourth control signal C4 for causing the transceiver 133 to transmit the confirmation request signal is outputted from the output interface 134c.

The confirmation request signal is received by the mobile device 50 through the second wireless communication. The mobile device 50 is configured to perform notification to the user 40 to request a specific operation upon reception of the confirmation request signal. The request for the operation may be made through at least one of a visual notification, an audio notification, and a tactile notification. The specific operation may be an actuation of a switch, or may be an input of a voice or a gesture. The switch may be a mechanical switch provided in the mobile device 50, or may be an image displayed on a screen of the mobile device 50.

It should be noted that, instead of the second wireless communication performed by the transceiver 133, an operation with respect to the mobile device 50 may be requested through a notification device provided at an appropriate position in the vehicle cabin 21. In this case, the fourth control signal C4 is configured to cause the notification device to perform an operation request.

When the user 40 performs a specific operation with respect to the mobile device 50, a confirmation signal is transmitted from the mobile device 50. The confirmation signal is received by the transceiver 133 through the second wireless communication.

The processor 134b determines whether the confirmation signal is received by the transceiver 133 (STEP27 in FIG. 20). When it is determined that the confirmation signal is received (YES in STEP27), the processor 134b outputs, from the output interface 134c, the first control signal C1 for causing the actuator 132 to actuate the movable portion 121 to cause the electronic key 12 to transmit the second signal S2 (STEP28). As a result, the operation control of the activator 32 by the control device 11 is enabled, so that the user 40 can activate the driving source of the vehicle 20.

When it is determined that the confirmation signal is not received by the transceiver 133 even if the prescribed time period has elapsed (NO in STEP27), the processor 134b does not perform the output of the first control signal C1 (STEP29). In brief, the second signal S2 as a response to the received first signal S1 is not transmitted. Accordingly, the operation control of the activator 32 by the control device 11 is disabled.

When it is determined that the prescribed time length has not elapsed at a time point when the first signal S1 having an intensity no less than the threshold value is detected (NO in STEP25), the processor 134b outputs, from the output interface 134c, the first control signal C1 for causing the actuator 132 to actuate the movable portion 121 to cause the electronic key 12 to transmit the second signal S2 (STEP28). In other words, he operation control of the activator 32 by the control device 11 is enabled without requesting an operation with respect to the mobile device 50.

According to such a configuration, it is possible to enhance security for a person who intends to activate the driving source of the vehicle 20 with the electronic key 12 housed in the casing device 13 disposed in the vehicle cabin 21 without carrying the mobile device 50, while ensuring convenience for the user 40 possessing the mobile device 50.

The above embodiments are merely illustrative for facilitating understanding of the gist of the presently disclosed subject matter. The configuration according to each of the above embodiments can be appropriately modified or changed without departing from the gist of the presently disclosed subject matter.

In the above embodiment, the electronic key 12 is housed in the housing section 131a of the casing device 13. However, at least a portion of the electronic key 12 including the communication device and the movable portion 121 may be housed in the housing section 131a.

In the above embodiment, the second wireless communication performed between the mobile device 50 and the transceiver 133 is the short-range wireless communication. In this case, it is possible to enhance the degree of freedom as for the position where the casing device 13 is disposed in the vehicle cabin 21. However, the second wireless communication may be the near field wireless communication.

In the above embodiment, the electronic key 12 housed in the casing device 13 is remotely controlled based on the lock/unlock signal LK transmitted from the mobile device 50, so that the locking/unlocking of the door 22 of the vehicle 20 by the locking/unlocking device 31 is performed. As a result, it is possible to enhance the security of the vehicle cabin 21 opened and closed by the door 22. In addition, it is possible to improve the security of the vehicle 20 as the mobile entity that is relatively easy to be subjected to theft.

However, the mobile entity on which the control device 11 and the locking/unlocking device 31 are installed is not limited to the vehicle 20. Examples of the mobile entity include railways, aircrafts, and ships. The mobile entity may not require a driver.

In addition, the opening/closing body to be locked/unlocked by the locking/unlocking device is not limited to the door 22 of the vehicle 20. Doors and windows in houses and facilities may also be an example of the opening/closing body. In this case, it is possible to enhance the security of a prescribed space opened and closed by the opening/closing body.

In the above embodiment, the battery control device 136 is described as a component of the casing device 13. However, the battery control device 136 can be used independently of the casing device 13.

For example, as illustrated in FIG. 21, the electronic key 12 in which the battery control device 136 is attached to the battery 122 may be placed on a tray device 60. The tray device 60 includes a radio source 61. The radio source 61 may include an antenna for transmitting a radio wave. Instead of the radio source 61, a permanent magnet may be used.

The battery control device 136 may have a configuration illustrated in FIG. 5 or FIG. 13. In this case, the power supply from the battery 122 to the electronic key 12 is cut off while the radio wave W generated from the radio source 61 or the magnetism M generated from the permanent magnet is applied to the battery control device 136.

For example, the tray device 60 may be disposed in a living space that is opened and closed by an opening/closing body. By bring the electronic key 12 into the living space and placing the same on the tray device 60, the user 40 can suppress the occurrence of a situation that the second signal S2 is unexpectedly transmitted in response to the first signal S1 coming in the living space. As a result, it is possible to enhance the security of the remote control system 10 including the electronic key 12.

The controlled device controlled by the second signal S2 transmitted from the electronic key 12 through the remote control from the mobile device 50 is not limited to the locking/unlocking device 31 installed in the vehicle 20. The operation of the above-described activator 32 or an anti-theft device of the vehicle 20, a security device, a lighting device, an air conditioner, and an audio-visual equipment in the vehicle 20 or the above-described house or facility can be appropriately controlled. The signal transmitted from the mobile device 50 for causing each of these controlled devices to operate may be an example of the trigger signal.

The controller 134 of the casing device 13 may be configured to perform authentication of the mobile device 50 in order to enable control of the controlled device such as the locking/unlocking device 31. In this case, the controller 134 is configured to cause the battery control device 136 to cut off the power supply from the battery 122 to the electronic key 12 until the authentication is succeeded. According to such a configuration, it is possible to suppress the occurrence of a situation that the controlled device is unexpectedly controlled while the authentication is not succeeded.

In the above embodiment, an inductive electromotive force or a magnetic force is utilized to cause the battery control device 136 to cut off the power supply from the battery 122 to the electronic key 12. Other examples of the force generated without contact may include, gravity, ultrasonic vibration, or the like.

The battery control device 136 need not be installed in the electronic key 12 together with the battery 122. For example, the relationship between the driving source of the vehicle 20 and the activator 32 for outputting the control signal CS for activator the driving source may be a relationship between the controlled device and the communication device. In this case, there may be provided a power supply control device configured to cut off the power supply from the power source installed in the vehicle 20 to the activator 32 until the authentication of the electronic key 12 is succeeded to enable the activation of the driving source. According to such a configuration, it is possible to suppress the occurrence of a situation that the driving source is unexpectedly activated while the authentication is not succeeded.

The present application is based on Japanese Patent Application No. 2021-011059 filed on Jan. 27, 2021, the entire contents of which are incorporated herein by reference.

What is claimed is:

1. A casing device adapted to be disposed in a prescribed space that is opened/closed by an opening/closing body, comprising:
a casing having a housing section adapted to house a communication device configured to cause a control device to perform control of a controlled device based on first wireless communication including reception of a first signal using a first frequency band and transmission of a second signal using a second frequency band as a response to the first signal;
an actuator configured to actuate a movable portion of the communication device housed in the housing section;
a transceiver configured to receive, based on second wireless communication, a trigger signal from a mobile device adapted to be carried by a user; and
a controller configured to cause the actuator to actuate the movable portion so as to cause the communication device to transmit the second signal in a case where the communication device receives the trigger signal;
a detector configured to an intensity of the first signal; and
a power supply control device configured to switch between a state that power supply from a power source to the communication device is enabled and a state the power supply is disabled,
wherein the controller is configured to cause the power supply control device to disable the power supply in a case where the intensity of the first signal detected by the detector is no less than a threshold value while the trigger signal is not received by the communication device.

2. The casing device according to claim 1, comprising:
a radio source,
wherein the power supply control device includes:
a coil; and
a switching element configured to disable the power supply based on an induced electromotive force generated in the coil,
wherein the controller is configured to cause the power supply control device to disable the power supply by applying a radio wave from the radio source to the coil.

3. The casing device according to claim 1, comprising:
a permanent magnet,
wherein the power supply control device includes:
a magnetic sensor configured to detect magnetism generated from the permanent magnet; and
a switching element configured to disable the power supply in a case where a strength of the magnetism exceeds a threshold value,
wherein the controller is configured to cause the power supply control device to disable the power supply by increasing the magnetism to be detected by the magnetic sensor.

4. The casing device according to claim 1, comprising:
a permanent magnet,
wherein the power supply control device includes:
a magnetic sensor configured to detect magnetism generated from the permanent magnet; and
a switching element configured to disable the power supply in a case where a strength of the magnetism is less than a threshold value or a pole of the magnetism is changed,
wherein the controller is configured to cause the power supply control device to disable the power supply by decreasing the magnetism to be detected by the magnetic sensor or changing the pole of the magnetism to be detected by the magnetic sensor.

5. The casing device according to claim 1,
wherein the controller is configured to cause the power supply control device to enable the power supply in a case where the intensity of the first signal detected by the detector cyclically becomes a value no less than the threshold value.

6. The casing device according to claim 1,
wherein the detector is configured to detect an intensity of the second signal; and
wherein the controller is configured to cause the power supply control device to disable the power supply in a case where the intensity of the second signal detected by the detector is no less than a threshold value while the trigger signal is not received by the communication device.

7. The casing device according to claim 1,
wherein the power source is a battery; and
wherein the power supply control device is configured to disable the power supply by electrically isolating a positive electrode and a negative electrode of the battery.

8. A remote control system, comprising:
a casing device adapted to be disposed in a prescribed space that is opened/closed by an opening/closing body;
a control device configured to perform control of a controlled device; and
a communication device configured to cause the control device to perform the control of the controlled device based on first wireless communication including reception of a first signal using a first frequency band and transmission of a second signal using a second frequency band as a response to the first signal,
wherein the casing device includes:
a casing having a housing section adapted to house the communication device;
an actuator configured to actuate a movable portion of the communication device housed in the housing section;
a transceiver configured to receive, based on second wireless communication, a trigger signal from a mobile device adapted to be carried by a user; and
a controller configured to cause the actuator to actuate the movable portion so as to cause the communication device to transmit the second signal in a case where the communication device receives the trigger signal;
a detector configured to an intensity of the first signal; and
a power supply control device configured to switch between a state that power supply from a power source to the communication device is enabled and a state the power supply is disabled,
wherein the controller is configured to cause the power supply control device to disable the power supply in a case where the intensity of the first signal detected by the detector is no less than a threshold value while the trigger signal is not received by the communication device.

9. The remote control system according to claim 8,
wherein the controlled device includes a locking/unlocking device configured to lock/unlock the opening/closing body.

10. The remote control system according to claim 8,
wherein the control device and the controlled device are installed in a mobile entity.

11. The remote control system according to claim 8,
wherein the communication device is a device adapted to be carried by a user.

12. A power supply control device configured to control power supply from a power source to a communication device configured to output information necessary for controlling a controlled device, comprising:
a conductive path being switchable between a conductive state that the power source and the communication device are electrically connected, and an insulative state that the power source and the communication device are electrically isolated; and
a switching element configured to switch the conductive path from the conductive state to the insulative state based on a force generated without contact.

13. The power supply control device according to claim 12,
wherein the force generated without contact is an induced electromotive force or a magnetic force.

14. The power supply control device according to claim 12,
wherein the power source is a battery; and
wherein a positive electrode and a negative electrode of the battery are electrically isolated in a case where the conductive path is in the insulative state.

15. The power supply control device according to claim 12, being adapted to be installed in the communication device as a device adapted to be carried by a user.
